(19) United States
(12) Patent Application Publication
(10) Pub. No.: US 2026/0054993 A1
(43) Pub. Date: Feb. 26, 2026

(54) Method for the production of graphite

(71) Applicant: Nippon Kornmeyer Carbon Group GmbH, Windhagen (DE)

(72) Inventors: Torsten KORNMEYER, Königswinter (DE); David KLEIN, Hennef (Sieg) (DE)

(73) Assignee: Nippon Kornmeyer Carbon Group GmbH, Windhagen (DE)

(21) Appl. No.: 19/102,332

(22) PCT Filed: Aug. 24, 2022
(86) PCT No.: PCT/EP2022/073616

§ 371 Date: Feb. 7, 2025

(30) Foreign Application Priority Data
Aug. 10, 2022 (WO) PCT/EP2022/072453

(51) Int. Cl. C01B 32/205

(52) U.S. Cl. CPC C01B 32/205; C01P 2006/10

(57) ABSTRACT

A method for producing graphite for use as a high-temperature insulation material or as a filter in the form of cubes, sheets or other components includes: producing a base material in the form of a mixture of carbon-based materials containing a raw material selected from foliage, moss or similar materials, such as grass, corn leaves or even sawdust, waste paper or natural fibres; soaking the mixture in a solvent over an extended period of time and comminuting it; adding a binder to the mixture until a largely homogeneous paste-like mixture is obtained; largely removing the solvent by pressing the mixture until a sufficiently stable and low-solvent pressed article is obtained; drying the pressed article until the remaining solvent has evaporated; and graphitising the pressed article to produce a block in a high-temperature furnace in an oxygen-free atmosphere, under inert gas, or in a vacuum at a temperature of >2,000° C.

### CROSS-REFERENCE TO RELATED APPLICATION

This application is a national stage application, filed under 35 U.S. C. § 371, of International Patent Application PCT/EP2022/073616, filed on Aug. 24, 2022, which claims the benefit of European Patent Application PCT/EP2022/072453, filed on Aug. 10, 2022.

### TECHNICAL FIELD

The disclosure relates to a process for producing graphite for use as high-temperature insulation material or as filter in the form of cubes, sheets or other components.

### BACKGROUND

High-temperature insulation materials are required in industrial manufacture wherever processes proceed at high temperatures and where high thermal radiance into the environment is undesirable since this leads to unnecessary energy losses. Since such high-temperature insulation materials are required in large volumes, it is advantageous when very substantially renewable and particularly cheap raw materials can be used as starting material.

Furthermore, the production process should also proceed in a very simple manner and be implementable in a minimum number of steps, such that overall costs are low.

### SUMMARY

It is an object of the disclosure to provide an inexpensive process for producing graphite for use as high-temperature insulation material or as filter or building materials, in which the starting materials which can be used are particularly inexpensive and renewable raw materials, and also used paper.

This is achieved in that
a base material in the form of a mixture of carbon-based materials comprising at least one raw material in the form of leaves, moss or similar materials, such as grass, corn leaves or else sawdust, used paper or natural fibers, which is produced in any mixing ratio of the materials,
in that the mixture is then softened over a prolonged period with a solvent and comminuted,
in that a binder is mixed into the mixture until the mixture is in the form of a largely homogeneous paste,
in that the solvent is largely removed by pressing the mixture until the resultant briquet has sufficient stability and a sufficiently low solvent level,
in that the briquet is dried until the residual solvent has evaporated, and
in that the briquet is graphitized to a block in a high-temperature furnace in an oxygen-free atmosphere under protective gas or under reduced pressure at a temperature of >2000° C.

In a first configuration, the solvent used is water.

Alternatively, the solvent used, which is simultaneously the binder, may also be polyacrylonitrile (PAN) dissolved in dimethyl sulfoxide (DMSO). In this case, however, it is necessary to immerse the briquet produced by pressing in water in order to cause polymerization of the polyacrylonitrile, and then to dry it.

The mixture can be pressed for production of the briquet by isostatic pressing as well.

In a development, a water-soluble binder is added to the mixture during the comminution in order to influence its density, the most favorable binder being in the form of syrup.

In addition, it is possible to mix wheat starch into the mixture in paste form in order to influence the density of the end product.

In a further configuration, the briquet is dried at elevated temperature in a stabilization step prior to the high-temperature treatment.

Finally, it is possible in a further processing step to superficially reprocess the high-temperature-resistant graphitized block in a mechanical processing step in order to produce standard components.

In addition, the graphitization temperature may be up to 3000° C.

In order to be able to better mechanically process the blocks or sheets of graphite produced, for example by machining or turning, it is appropriate to densify the material to a density of <1 g/cm³ by impregnating. Phenolic resin, phosphate or pitch can be used for impregnation.

The impregnated graphite can then be re-graphitized, and this operation can be repeated several times.

The result is inexpensive graphite components having improved mechanical properties that are suitable for use as filters in the form of cubes, sheets or other components.

### DETAILED DESCRIPTION

The invention will now be more particularly explained with reference to a working example.

In order to manufacture graphitized high-temperature insulation material, filters or else building materials of any shape from inexpensive starting materials, a base material is first produced in the form of a mixture of carbon-based materials.

This base material should include at least one raw material in the form of leaves, moss or similar materials, such as grass, corn leaves or else sawdust, used paper or natural fibers, which is produced in any mixing ratio of these raw materials.

The mixture is subsequently softened over a prolonged period in a solvent, such as water, and then mechanically comminuted, and a binder is mixed into the mixture after comminution until a largely homogeneous mixture in paste form is formed in the course of stirring; comminution is possible, but not necessarily always necessary. Softening of the mixture, depending on the materials used, may be necessary for between 1 hour and several days.

Subsequently, the solvent is largely removed from the mixture by pressing thereof until the resultant briquet has sufficient stability and a sufficiently low solvent level, and is easy to handle, and then the briquet is dried under air, in an oven or a dryer, until the rest of the solvent has evaporated. It is necessary here to be absolutely sure that no solvent residue remains in the briquet, which could cause damage to the briquet by outgassing in the subsequent high-temperature treatment.

Finally, the briquet is graphitized to a block in a high-temperature furnace in an oxygen-free atmosphere under protective gas or under reduced pressure at a temperature of >2000° C., where the graphitization temperature may be up to 3000° C.

By way of precaution, the briquet may be dried at elevated temperature in an additional stabilization step prior to high-temperature treatment.

The graphite block can then be divided into the desired components by mechanical processing.

Alternatively, rather than water, the solvent used, which is simultaneously the binder, may also be polyacrylonitrile (PAN) dissolved in dimethyl sulfoxide (DMSO). In this case, however, it is necessary to immerse the briquet produced by pressing in water in order to cause polymerization of the polyacrylonitrile, and then to dry it.

The mixture can be pressed for production of the briquet by isostatic pressing as well.

In addition, it is possible to add a water-soluble binder to the mixture of the carbon-based materials during the comminution in order to influence its density, the most favorable binder being sugar in the form of syrup.

Alternatively or additionally, wheat starch may be mixed into the mixture in paste form in order to influence the density of the end product.

Finally, it is possible in a further processing step to superficially reprocess the high-temperature-resistant graphitized block in a mechanical processing step in order to produce standard components.

In order to be able to better mechanically process the blocks or sheets of graphite produced, such as by machining or turning, it is appropriate to densify the material to a density of <1 g/cm³ by impregnating, for which it is possible to use phenolic resin, phosphate or pitch for impregnation.

The impregnated graphite can then be re-graphitized, and this operation can be repeated several times.

The result is that it is possible to use the process to produce inexpensive graphite components having improved mechanical properties that are suitable for use as high-temperature insulation material or as filters in the form of cubes, sheets or other components.

1. -14. (canceled)

15. A process for producing graphite for use as a high-temperature insulation material or as a filter, comprising:
producing a mixture of at least two carbon-based materials, at least one of the at least two carbon-based material being selected from the group consisting of leaves, moss, grass, corn leaves, sawdust, used paper, or natural fibers;
softening the mixture with a solvent and comminuting the mixture;
mixing a binder into the mixture until the mixture is a homogeneous paste;
removing the solvent by pressing the mixture and thereby producing a briquet that is stable;
drying the briquet until residual solvent remaining in the briquet after the pressing has evaporated; and
graphitizing the briquet to form a graphitized block in a high-temperature furnace in an oxygen-free atmosphere under protective gas or under reduced pressure at a graphitization temperature of >2000° C.

16. The process as claimed in claim 15,
wherein the solvent is water.

17. The process as claimed in claim 15,
wherein the solvent and the binder are polyacrylonitrile dissolved in dimethyl sulfoxide.

18. The process as claimed in claim 17, further comprising immersing the briquet in water and thereby causing polymerization of the polyacrylonitrile.

19. The process as claimed in claim 15,
wherein the pressing the mixture for producing the briquet is undertaken by isostatic pressing.

20. The process as claimed in claim 15, further comprising
adding a further binder to the mixture during the comminuting in order to influence a density of the mixture,
wherein the further binder is water-soluble.

21. The process as claimed in claim 20,
wherein the water-soluble binder is sugar in the form of syrup.

22. The process as claimed in claim 15, further comprising
mixing wheat starch into the homogeneous paste in order to influence a density of an end product.

23. The process as claimed in claim 15, further comprising
processing a surface of the graphitized block in a mechanical processing step in order to produce a standard component.

24. The process as claimed in claim 15,
wherein the graphitization temperature is less than 3000° C.

25. The process as claimed in claim 15, further comprising impregnating the graphitized block and causing the graphitized block to have a density of <1 g/cm³.

26. The process as claimed in claim 25,
wherein impregnating the graphitized block is performed with phenolic resin, phosphate, or pitch.

27. The process as claimed in claim 25, further comprising
re-graphitizing the graphitized block after the impregnating.
